(19) United States
(12) Patent Application Publication
(10) Pub. No.: US 2026/0352056 A1
(43) Pub. Date: Nov. 5, 2026

(54) NACELLE SYSTEM FOR AN ELECTRIC MACHINE

(71) Applicant: SAFRAN ELECTRICAL & POWER, Blagnac Cedex (FR)

(72) Inventors: Christophe Elie Simon Marie Castelli, Moissy Cramayel (FR); Frédéric Yziquel, Moissy Cramayel (FR); Franck Payen, Moissy Cramayel (FR); Fabrice Cordeau, Moissy Cramayel (FR)

(73) Assignee: SAFRAN ELECTRICAL & POWER, Blagnac Cedex (FR)

(21) Appl. No.: 19/101,807

(22) PCT Filed: Jul. 27, 2023
(86) PCT No.: PCT/FR2023/051193

§ 371 Date: Feb. 6, 2025

(30) Foreign Application Priority Data
Aug. 8, 2022 (FR) FR2208181

(51) Int. Cl. H02K 5/04; B64D 29/00; H02K 5/26; H02K 9/14; H02K 9/22

(52) U.S. Cl. CPC H02K 5/04; H02K 5/26; H02K 9/14; H02K 9/227; B64D 29/00

(57) ABSTRACT

The invention relates to a nacelle system for an electric machine provided with cooling fins, which comprises a fairing configured to match the shape of the electric machine and an adjustment device configured to hold the fairing and press it against the cooling fins for cooling the electric machine, the fairing comprising at least one portion of fairing, the adjustment device comprising at least one connection means arranged between two ends of portion of airing. In particular, the nacelle system enables the electric machine to be cooled more effectively by improved air circulation and improves the performance of the electric machine.

### TECHNICAL FIELD

The present invention relates to a nacelle system for improving the cooling of cooling fins of an electric machine.

In particular, the present invention relates to a system for increasing the amount of heat dissipated by the fins.

In general, the present invention applies to any machine cooled by a fluid surrounding the electric machine. However, an application of the invention relates to cooling an electric aircraft engine.

### PRIOR ART

During operation, an aircraft motor is subjected to thermal stress and therefore requires cooling in order to ensure optimal operation. An electric motor requires efficient cooling the more the motor temperature strongly influences the performance of the motor. In the case of cooling by air circulation, the motor is advantageously provided with thermally conductive fins increasing the heat exchange surface between the motor and the air in which the aircraft operates.

The aircraft may comprise a fairing in the vicinity of the motor, for example surrounding the motor. The fairing is usually positioned to protect the motor from possible shocks but makes the motor cooling ineffective. In addition, the air flow arriving on the fins does not extract enough calories from the fins and the motor cooling is not efficient. This situation may lead to an oversizing of the motor and therefore to an excess mass of the aircraft.

### DISCLOSURE OF THE INVENTION

The present invention therefore aims to overcome all or some of the aforementioned disadvantages and proposes improving the cooling of cooling fins of an electric machine by enabling efficient cooling of the fins.

The present invention relates to a nacelle system for an electric machine provided with cooling fins, comprising a fairing configured to conform to the shape of the electric machine and an adjustment device configured to hold the fairing and press it around the cooling fins of the electric machine, the fairing comprising at least one fairing portion, the adjustment device comprising at least one connecting means disposed between two ends of a fairing portion.

The nacelle system makes it possible, thanks to the adjustment device, to be positioned as close as possible to the fins and to optimise the fluid flows around the electric machine in order to increase the amount of heat exchanged between the fins and the fluids to which the calories are dissipated. In particular, the fairing is positioned so as to participate in the heat transfer between the fins and the air, the fairing makes it possible for example to direct an air flow cooling the fins.

Advantageously, the fairing comprises holes distributed along a periphery of the
fairing, the adjustment device comprising fastening means disposed in the holes so as to fasten the fairing to the electric machine.

Preferably, the connecting means comprises an assembly tie rod and at least two brackets, the two brackets being joined by the assembly strut.

In one embodiment, the fairing comprises several fairing portions, the adjustment device comprising several connecting means each disposed between two ends of fairing portions.

Optionally, the system comprises an interface material in contact with the fairing and configured to be in contact with the cooling fins, the interface material being configured to protect the fins and/or enable a thermal interface between the fins and the fairing.

Advantageously, the fairing comprises a thermally conductive material.

Preferably, the adjustment device comprises a locking means for locking the adjustment of the adjustment device.

Optionally, the locking means comprises a self-locking nut.

The present invention also relates to an electric machine comprising a body, thermally conductive fins distributed around the body, and a nacelle system as defined previously.

Advantageously, the fairing comprises a material having a coefficient of thermal expansion corresponding to the coefficient of thermal expansion of the material of the body of the electric machine.

### BRIEF DESCRIPTION OF THE DRAWINGS

Further objectives, features and advantages of the invention will appear upon reading the following description, given solely by way of a non-limiting example, and made with reference to the appended drawings in which:

FIG. 1 schematically illustrates an electric machine according to the invention;

FIG. 2 schematically illustrates an enlargement of an area of FIG. 1 centred on the connection means;

FIG. 3 schematically illustrates a nacelle system according to a first embodiment of the invention; and

FIG. 4 schematically illustrates a nacelle system according to one embodiment of the invention.

### DETAILED DISCLOSURE OF AT LEAST ONE EMBODIMENT

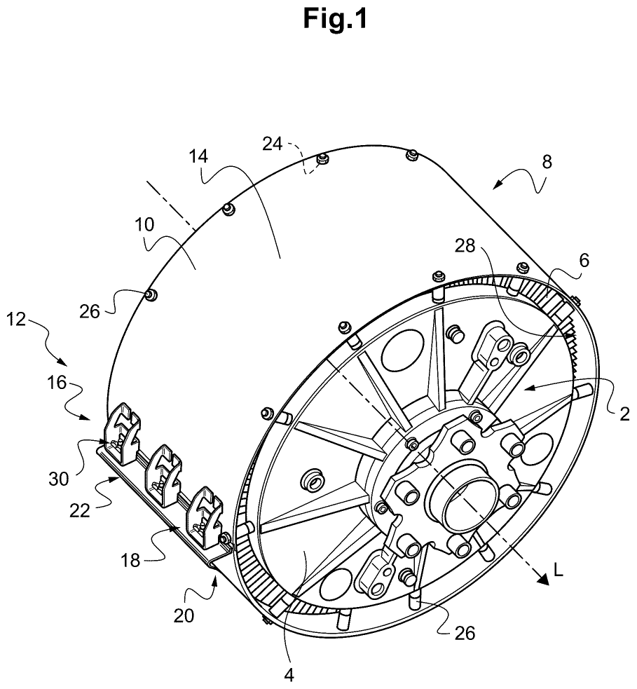

FIG. 1 schematically shows an electric machine 2. The electric machine 2 comprises a cylindrical-shaped body 4, thermally conductive fins 6 distributed around the body 4 and a nacelle system 8. The nacelle system 8 comprises a fairing 10 configured to fit the shape of the electric machine 2 and an adjustment device 12 configured to hold the fairing 10 and press it around the fins 6. By nacelle system 8, we mean the assembly composed of the fairing 10 and the adjustment device 12.

The electric machine 2 comprises for example an aircraft motor fitted with thermally conductive fins 6 configured to carry out a heat exchange between the fins 6 and the air in which the aircraft moves.

The nacelle system 8 is intended to improve the cooling of the cooling fins 6 of the electric machine 2.

The fairing 10 comprises a fairing 10 portion 14, for example a thin metal sheet, for example 1 mm thick, formed for example of an aluminium alloy. In another embodiment, the fairing 10 portion 14 is formed from another metal material, or polymer, or composite, or thermoplastic, or thermosetting, or an aluminium alloy. The portion 14 of fairing 10 is slightly flexible and held in shape by the adjustment device 12 to best fit the fins 6 of the electric machine 2.

Here, the shape is substantially cylindrical so that the fairing 10 takes the form of an annular ring with a defined longitudinal dimension, for example of the same dimension as a dimension of the electric machine 2 along the longitudinal axis L, and with a circular, or elliptic, cross-section, or substantially similar to the cross-section of the electric machine 2.

The adjustment device 12 comprises at least one connecting means 16. The connecting means 16 comprises for example an assembly tie rod 18 connecting two ends 20 of the portion 14 of fairing 10 so as to bring the two ends 20 together or to maintain the two ends 20 at a constant distance from one another. Advantageously, the adjustment device 12 comprises a bracket 22 disposed on an end 20. Preferably, the adjustment device 12 comprises a second bracket 22 disposed on the second end 20, the two brackets 22 being connected by the tie rod 18. The adjustment device 12 makes it possible, for example, to bring the two ends 20 of the portion 14 of fairing 10 into contact. The brackets 22 also make it possible to reinforce the fairing 10.

In the example of FIG. 1, the nacelle system 8 comprises a portion 14 of fairing 10 held by three assembly tie rods 18 holding the fairing 10 in a cylinder shape of constant circular cross-section along the longitudinal axis of the fairing 10. In addition, the adjustment device 12 makes it possible to maintain the fairing 10 in a shape substantially similar to the cross-section of the electric machine 2. Advantageously, the tie rods 18 are removable so as to be able to separate the two ends 20 and thus be able to remove the fairing 10 from the electric machine 2.

A tie rod 18 is for example an adjustable mechanical part made with a screw and/or lever closure and/or toggle closure system. In particular, a tie rod 18 connects the brackets 22 by making it possible to adjust the distance between the brackets 22. In the example of FIG. 1, each of the three tie rods 18 connects two brackets 22 so as to maintain the two brackets 22 at a constant distance from one another.

Preferably, the fairing 10 comprises holes 24 perforated in the material of the fairing 10 or made during shaping of the fairing 10 for example during a stamping process and distributed along a periphery of the fairing 10, for example uniformly. Advantageously, the adjustment device 12 comprises fastening means 26 configured to be arranged in the holes 24 and to secure the fairing 10 to the electric machine 2, preferably in contact with the fins 6 so as to optimise fluid flows for cooling the electric machine 2. The fastening means 26 comprise for example screws and/or pins and/or washers.

In one embodiment, the holes 24 are distributed unevenly over the fairing 10. Preferably, the fins 6 are in contact with the fairing 10 such that the fairing 10 also performs the heat diffuser function.

In one embodiment, the nacelle system 8 comprises an interface material 28 in contact with the fairing 10 on the one hand and with the fins 6 on the other hand so as to protect the fins 6 from contact with the fairing 10, in particular in the case of fragile fins 6.

The interface material 28 comprises for example a foam or a soft material such as Teflon. Preferably, the interface material 28 comprises a thermally conductive material covering an inner surface of the fairing 10. In addition, the interface material 28 transmits the heat dissipated by the fins 6 to the fairing 10. The interface material 28 thus participates in cooling the fins 6 by forming a thermal interface between the fins 6 and the fairing 10. Advantageously, the adjustment device 12 makes it possible to support the fairing 10 on the fins 6 so that the force exerted by the fairing 10 on the fins 6 is distributed substantially evenly over the fins 6.

The fairing 10 is for example attached to the electric machine 2 by removable fastening means 26 so as to be able to detach the fairing 10 from the electric machine 2. In addition, the fastening means 26 hold the fairing 10 in a substantially cylindrical shape around the fins 6.

When the electric machine 2 is housed in the fairing 10, the fairing 10 makes it possible to channel the air along a surface of the fins 6 so as to increase the amount of heat exchanged between the fins 6 and the air. In addition, an air flow is directed to the fins 6 and the cooling of the electric machine 2 is improved in particular thanks to a reduction of the pressure losses and/or a decrease of the air leaks out of the fins 6. Advantageously, the air flow is concentrated exclusively in the fins 6. Furthermore, the heat exchange surface of the fins 6 when the electric machine 2 is housed in the enclosure 10 is greater than the heat exchange surface of the fins 6 when the electric machine 2 is not housed in the fairing 10.

Optionally, openings (not shown) are made in the material of the fairing 10 so as to increase the air flow cooling the fins 6 via a secondary air import.

The air ducting improves the performance of the electric machine 2. For example, in the case of the aircraft motor, in particular electric, the ducting makes it possible to increase the capacity of the motor to provide power to propel the aircraft.

Preferably, the adjustment device 12 allows the fairing 10 to perfectly fit the shape of the electric machine 2 fitted with fins 6 so that all the available air cools the fins 6.

Advantageously, the fairing 10 comprises a thermally conductive material so as to dissipate the heat emitted by the fins 6 and transmitted to the fairing 10. In this case, the fairing 10 comprises a material having a coefficient of thermal expansion corresponding to the coefficient of thermal expansion of a material of the electric machine 2, corresponding in the case of the aircraft motor to the coefficient of thermal expansion of a material of the body 4 of the aircraft motor.

In addition, the coefficient of thermal expansion of the material of the fairing 10 is equal to the coefficient of thermal expansion of the material of the electric machine 2. Preferably, the material of the fairing 10 is the same as that forming the electric machine 2 so that the thermal expansions of the electric machine 2 and the fairing 10 are of the same nature.

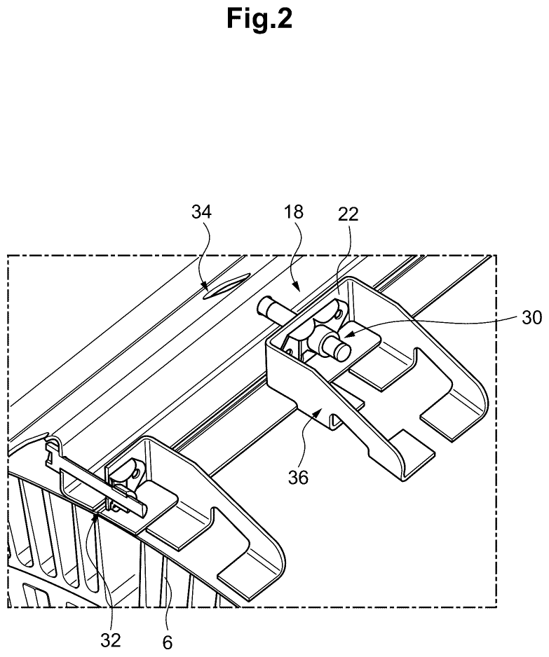

A schematic representation of an enlargement of an area of FIG. 1 showing in particular a detailed view of a part of the adjustment device 12 has been shown in FIG. 2. The adjustment device 12 comprises a tie rod 18 connecting two ends 20 of the fairing 10 and a locking means 30 so as to lock the adjustment of the tie rod 18.

The locking means 30 is configured to lock the adjustment of the adjustment device 12. The locking means 30 makes it possible, for example, to avoid relative movements between the fairing 10 and the adjustment device 12 during vibrations of the fairing 10 and/or the electric machine 2.

The locking means 30 comprises, for example, a nut provided with a device preventing the nut from loosening without preventing the removal of the nut. The locking means 30 comprises for example a castle nut and/or an incorporated ring nut and/or a lock nut and/or a self-locking nut.

The adjustment device 12 comprises a first bracket 22 disposed on an end 20, the end 20 comprising a dropped edge 32. The dropped edge 32 makes it possible, for example, to reinforce the end 20, to protect a user when installing the nacelle system 8 and to facilitate the alignment of the two ends 20 of the fairing 10. The dropped edge 32 allows a watertight junction of the two ends 20 of the fairing 10.

Advantageously, the bracket 22 comprises an access opening 34 opposite the tie rod 18 so as to facilitate access to the tie rod 18 and thus facilitate installation thereof.

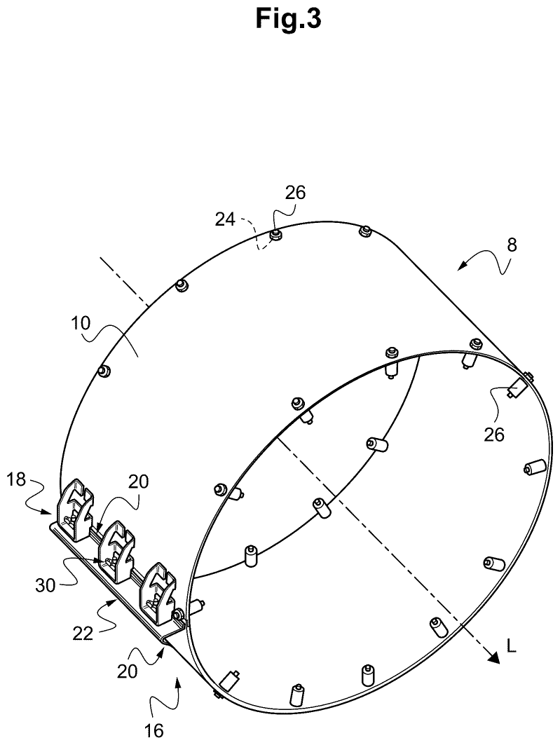

The adjustment device 12 comprises a fastening device 36 provided with a bracket 22, the fastening device 36 being disposed on the second end 20. The fastening device 36 makes it possible to reinforce the holding of the tie rod 18 on the second end 20. FIG. 3 shows schematically the nacelle system 8 of FIG. 1 removed from the electric machine 2. The removal of the fairing 10 of the electric machine 2 is for example facilitated by the use of an assembly tie rod 18 as described previously.

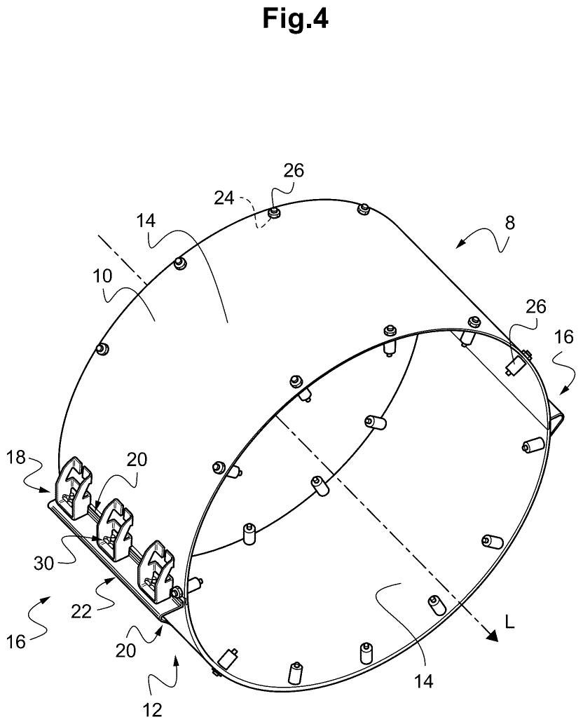

In another embodiment shown schematically in FIG. 4, the fairing 10 of the nacelle system 8 comprises two portions 14 fairing 10 of identical dimensions. In another embodiment, the portions 14 of fairing 10 may be in different numbers and of different dimensions from each other. Optionally, the portions 14 of fairing 10 comprise various materials, for example a thermoplastic material, a thermosetting material, a composite material or an aluminium alloy.

The portions 14 of fairing 10 are connected to each other by several connection means 16. The nacelle system 8 shown comprises two identical connection means 16. In another embodiment, the nacelle system 8 comprises a different number of connection means 16, the connection means 16 being identical or different.

In FIG. 4, each connection means 16 is disposed between two portions 14 of fairing 10 so that the portions 14 of fairing 10 form the fairing 10. More precisely, each connection means 16 is disposed between two different ends 20 of a portion 14 of fairing 10. The connection means 16 comprise for example tie rods 18, and/or screws, and/or nuts and/or rivets. Advantageously, the connection means 16 are removable so as to be able to detach the portions 14 of fairing 10.

In the embodiment illustrated in FIG. 4, each connection means 16 comprises three assembly tie rods 18 of the fairing 10. Each tie rod 18 is disposed between two brackets 22. The number of portions 14 of fairing 10 makes it possible, for example, to best adjust the fairing to the shape of the electric machine 2 against which the fairing 10 is intended to be pressed. The number of connection means 16 and their nature ensure, for example, that the fairing 10 is properly pressed against the fins 6 of the electric machine 2 and/or that the adjustment of the fairing 10 around the electric machine 2 will not be changed when the electric machine 2 is used.

In another embodiment, the connection means 16 is simply a hinge, or any other method of attaching the portions 14 of fairing 10 to each other. At least one connection means 16 remains adjustable as described previously.

In another embodiment, the adjustment device 12 makes it possible to maintain the fairing 10 in a shape corresponding to a non-cylindrical-shaped electric machine 2 so that the fairing 10 is disposed around the fins 6 of the electric machine 2, in particular by means of several portions 14 of fairing 10 and connection means 16.

In a particular embodiment, a fairing as described above adapts for example to an electric motor and/or to a heat engine and/or to a generator and/or to a fan and/or to an exchanger. The electric machine 2 comprises for example an intelligent motor comprising an electric motor and its electronic control member advantageously used in the aeronautical field.

In an embodiment, an aircraft motor comprising a nacelle system 8 as defined previously forms a lightweight and compact aircraft motor module ready to be installed in an aircraft.

In particular, the structure of the motor module makes it possible to ensure efficient motor cooling and this independently of the aircraft in which the motor module is installed.

The installation of the motor module in an aircraft is facilitated in particular thanks to the modular nature of the motor module, to the efficient and autonomous cooling of the motor module, and to the removable nature of the nacelle system 8.

1. Nacelle system for an electric machine provided with cooling fins, the system comprising a fairing configured to fit the shape of the electric machine and an adjustment device configured to hold the fairing and press it around the cooling fins of the electric machine, the fairing comprising at least one fairing portion, the adjustment device comprising at least one adjustable connection means disposed between two ends of portion of fairing.

2. The system according to claim 1, wherein the fairing comprises holes distributed along a periphery of the fairing and wherein the adjusting device comprises fastening means arranged in the holes so as to secure the fairing to the electric machine.

3. System according to claim 1, wherein the connection means comprises an assembly tie rod and at least two brackets each disposed on an end of a portion of fairing, the two brackets being joined by the assembly tie rod.

4. System according to claim wherein the fairing comprises a plurality of portions of fairing, the adjusting device comprising a plurality of connection means each disposed between two ends of portions of fairing.

5. System according to claim 1, comprising an interface material in contact with the fairing and configured to be in contact with the cooling fins, the interface material being configured to protect the fins and/or provide a thermal interface between the fins and the fairing.

6. System according to claim 1, wherein the fairing comprises a thermally conductive material.

7. System according to claim 1, wherein the adjustment device comprises a locking means for locking the adjustment of the adjustment device.

8. System according to claim 7, wherein the locking means comprises a self-locking nut.

9. Electric machine comprising a body, thermally conductive fins distributed around the body, and a nacelle system according to claim 1.

10. The electric machine according to claim 9, wherein the enclosure comprises a material having a coefficient of thermal expansion corresponding to the coefficient of thermal expansion of the material of the body of the electric machine.
